(19) United States
(12) Patent Application Publication
(10) Pub. No.: US 2009/0087348 A1
(43) Pub. Date: Apr. 2, 2009

(54) SENSOR APPLICATIONS

(76) Inventors: Richard Otto Claus, Eggelston, VA (US); Jennifer Hoyt Lalli, Blacksburg, VA (US)

Correspondence Address: SHERR & VAUGHN, PLLC, 620 HERNDON PARKWAY, SUITE 200, HERNDON, VA, 20170, US

(21) Appl. No.: 12/253,303

(22) Filed: Oct. 17, 2008

Related U.S. Application Data
(63) Continuation-in-part of application No. 12/033,889, filed on Feb. 19, 2008.
(60) Provisional application No. 60/890,297, filed on Feb. 16, 2007.
(60) Provisional application No. 60/980,748, filed on Oct. 17, 2007.
(60) Provisional application No. 60/980,755, filed on Oct. 17, 2007.

(51) Int. Cl. G01N 27/00; B01J 19/00; G01N 21/01; G01N 25/00; B05D 3/00

(52) U.S. Cl. 422/82.02; 422/68.1; 422/82.09; 422/82.12; 427/299

(57) ABSTRACT

A sensor that includes an assembly having a flexible base material and a flexible material layer formed on the flexible base material. Both the flexible base material and the flexible material layer have shrinkable and/or stretchable properties. The flexible base material may include a shrinkable polymer (e.g. PVC/PET or “shrink wrap”), which may shrink up to 500%. The flexible base material may include a stretchable polymer (e.g. Mylar), which may be stretched by at least 1000%. These stretchable and shrinkable properties may be exhibited without substantial functional degradation of either the flexible base material and/or the flexible material layer.

The present application is a continuation-in-part of U.S. application Ser. No. 12/033,889 filed Feb. 19, 2008, which claims priority to U.S. Provisional Patent Application No. 60/890,297 (filed Feb. 16, 2007), which are both hereby incorporated by reference in their entirety. The present application claims priority to U.S. Provisional Patent Application No. 60/980,748 (filed Oct. 17, 2007) and U.S. Provisional Patent Application No. 60/980,755 (filed Oct. 17, 2007), which are all hereby incorporated by reference in their entireties.

### BACKGROUND

Conductive materials (e.g. gold, copper, silver, etc.) are used in many technological applications. For example metals are used as wires to transmit electricity. In similar examples, sheets of metal are used to transfer heat, protect against electromagnetic radiation (e.g. radio waves), antennas, and many other applications. However, conductive materials have traditionally been in the form of a bulk metal (e.g. a piece of gold or copper) that is purified and formed in a specific shape based on the application. These traditional conductive materials cannot be stretched, shrunk, or have flexible properties. Accordingly, traditional conductive materials have limited applications based on their natural rigid form and composition.

A sensor is device that detects a change in, or determines the value of, a physical parameter. Conventional sensors utilizing conventional materials are typically classified according to the parameter they sense. Commonly available sensors include temperature sensors, pressure sensors, accelerometers, flow sensors, stress/strain sensors, dielectric sensors, conductivity sensors, shock sensors, and vibration sensors.

In general, the accuracy and usage of conventional sensors are often limited due to the bulk and rigidity of the sensor. In order to overcome these restrictions attempts have been made to incorporate flexible thin films into sensors. Typically such films are constructed using a chemical vapor deposition (CVD) process where a metallic layer is deposited on a flexible substrate. However, the resulting structure can sustain only limited strain (about 10%) before the surface metal coating cracks, spalls, debonds and otherwise deteriorates.

### SUMMARY

Embodiments relate to a sensor that includes an assembly having a flexible base material and a flexible material layer formed on the flexible base material. Both the flexible base material and the flexible material layer have shrinkable and/or stretchable properties. The flexible base material may include a shrinkable polymer (e.g. PVC/PET or “shrink wrap”), which may shrink up to 500%. The flexible base material may include a stretchable polymer (e.g. Mylar), which may be stretched by at least 1000%. These stretchable and shrinkable properties may be exhibited without substantial functional degradation of either the flexible base material and/or the flexible material layer.

The flexible material layer may include at least one nano-particle layer (e.g. including gold nano-clusters) and at least one linking agent layer. The at least one nano-particle layer is bonded to the at least one linking agent layer (e.g. through electrostatic and/or covalent bonding). In embodiments, in response to shrinking, stretching or deforming the flexible base material the geometry of the nano-particles of the at least one nano-particle layer changes.

### DRAWINGS

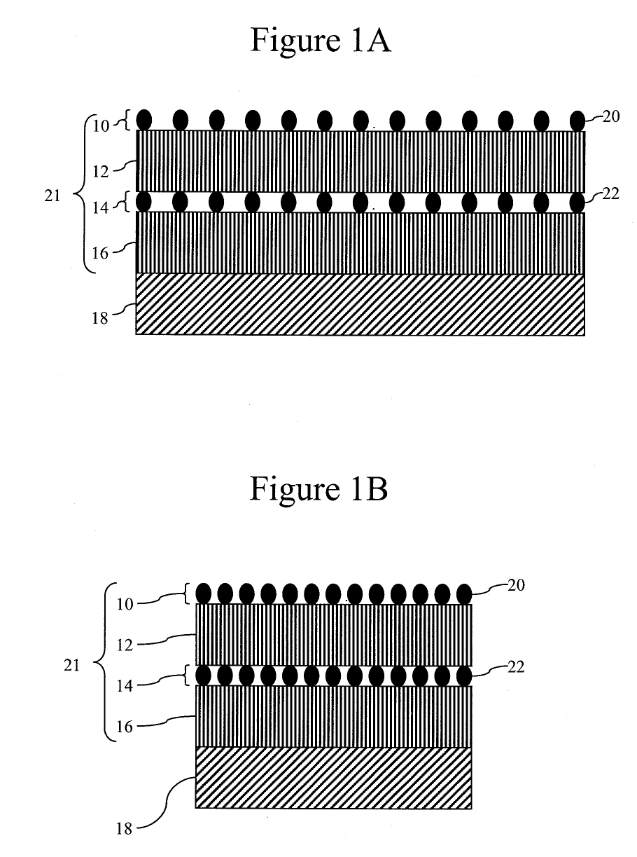

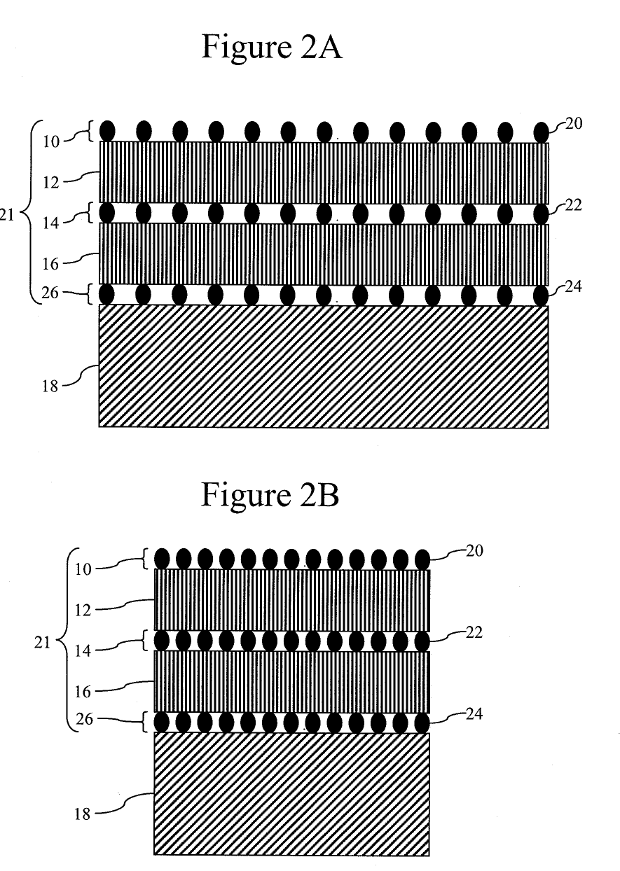

Example FIGS. 1A, 1B, 2A, and 2B illustrate a flexible material layer formed on a flexible base material that have shrinkable properties, in accordance with embodiments.

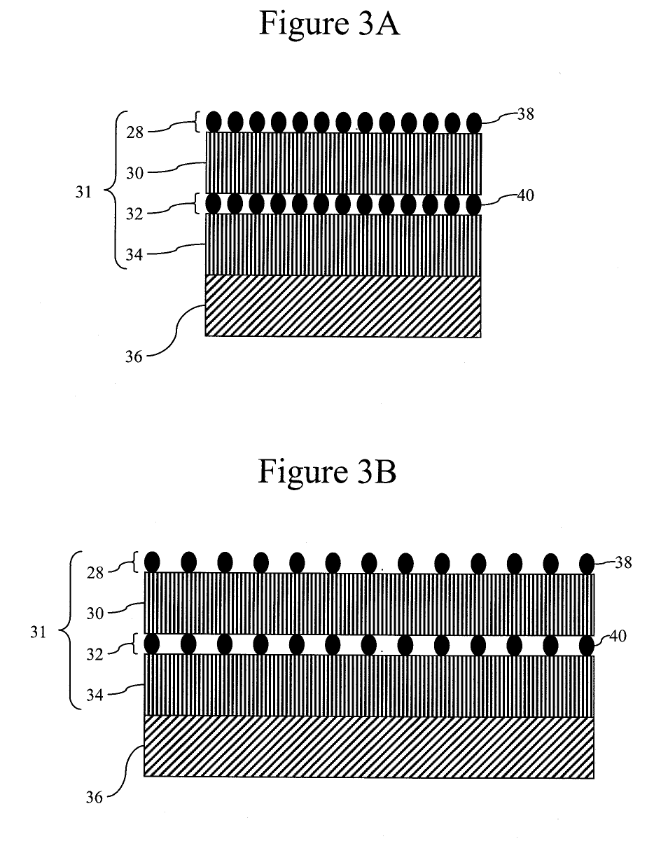

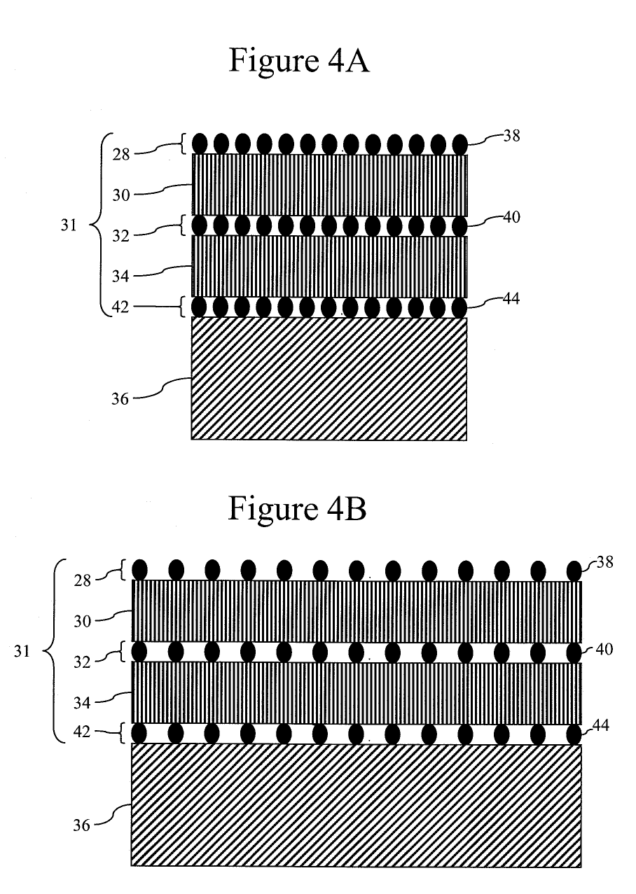

Example FIGS. 3A, 3B, 4A, and 4B illustrate a flexible material layer formed on a flexible base material that have stretchable properties, in accordance with embodiments.

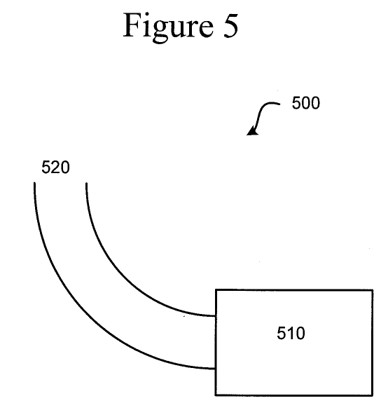

Example FIG. 5 illustrates a sensor that includes a flexible sensor material, in accordance with embodiments.

### DESCRIPTION

Example FIGS. 1A and 1B illustrate a flexible base material 18 with a flexible material layer 21 formed on the flexible base material 18 that have shrinkable properties. Flexible material layer 21 includes nano-size (e.g., conductive or non-conductive) particles 20, 22 that do not substantially deteriorate due to shrinking of flexible base material 18, in accordance with embodiments.

FIG. 1A illustrates first linking agent material layer 16 (of flexible material layer 21) bonded to flexible base material 18. First linking agent material layer 16 may be also bonded to first nano-particle material layer 14. First nano-particle material layer 14 may be also bonded to second linking agent material layer 12. Second linking agent material layer 12 may be also bonded to second nano-particle material layer 10. Although only two linking agent layers (i.e. first linking agent material layer 16 and second linking agent material layer 12) and two nano-particle material layers (i.e. first nano-particle material layer 14 and second nano-particle material layer 10) are illustrated, embodiments may include any number of linking agent material layers and nano-particle material layers (including just one nano-particle material layer and/or linking agent material layer).

In embodiments, the flexible material layer 21 may be formed directly on the flexible base material 18. The flexible material layer 21 may be substantially free standing, in embodiments. In embodiments, the flexible base material 18 may be supported by a rigid substrate and then removed from the rigid substrate after formation of the flexible material layer 21 (e.g. as a decal). In embodiments, the flexible base material 18 may be supported by a support structure (e.g. a frame, as illustrated in FIG. 5) during formation of the flexible material layer 21. By forming a flexible material layer on a flexible base material, fabrication and processing efficiency may be optimized.

First nano-particle material layer 14 includes nanoparticles 22. In embodiments, nano-particles 22 may be conductive nano-particles (e.g. nano-size gold clusters). Nano-particles 22 may be individually bonded to first linking agent material layer 16. Bonding of nano-particles 22 to first linking agent material layer 16 may be either electrostatic bonding and/or covalent bonding. Nano-particles 22 may not be substantially bonded to each other. Accordingly, as first linking agent material layer 16 expands or contracts, the bond between the nano-particles 22 and first linking agent material layer 16 is not significantly compromised.

As illustrated in example FIG. 1B, an apparatus including flexible base material 18 and flexible material layer 21 may be shrunk. When shrunk, nano-particles 22 remain bonded to first linking material layer 16 as it is shrunk with the flexible base material 18. Since nano-particles 22 of first nano-particle material layer 14 are not bonded to each other, shrinking of first linking material layer 16 does not significantly compromise the robustness of first nano-particle material layer 14.

Although nano-particles 22 in first nano-particle material layer 14 are not bonded to each other, nano-particles 22 may be arranged close enough to each other, such that they may be electrically coupled to each other. In other words, in embodiments, electrical current may flow between adjacent nano-particles 22 in first nano-particle material layer 14. In fact, in embodiments, the rate of electrical conduction (i.e. electrical resistance) in first nano-particle material layer 14 (e.g. including gold nano-clusters) may be comparable and/or exceed that of solid gold (due to lattice inefficiencies in solid gold). Shrinking of first linking material layer 16 may increase the conductivity of first nano-particle material layer 14 (due to a decrease in distance between neighboring nano-particles 22). Shrinking may be accomplished by mechanical, electrical, thermal, and/or light stimulus.

Second linking agent material layer 12 may also be bonded to first nano-particle material layer 14, with the same or similar bonding mechanism as the bonding between first nano-particle material layer 14 and first linking agent material layer 16, in accordance with embodiments. In embodiments, first linking agent material layer 16 and second linking agent material layer 12 may include the same material and/or configuration. In embodiments, first linking agent material layer 16 and second linking agent material layer 12 may include different materials and/or configurations.

Second nano-particle material layer 10 may be bonded to second linking agent material layer 12 with the same or similar bonding mechanism as the bonding between first nano-particle material layer 14 and first linking agent layer 16. Additional linking agent material layer(s) and/or nano-particle material layer(s) may be formed over second nano-particle material layer 10, in accordance with embodiments. In embodiments, first nano-particle material layer 14 and second nano-particle material layer 10 may include the same material (i.e. nano-particles 20 and nano-particles 22 may be the same type of nano-particles) and/or configuration. In embodiments, first nano-particle material layer 14 and second nano-particle material layer 10 may include different materials (i.e. nano-particles 20 and nano-particles 22 may be different types of nano-particles) and/or configurations.

As illustrated in example FIGS. 2A and 2B, a nano-particle material layer (e.g. third nano-particle material layer 26 with nano-particles 24) may be formed between first linking agent layer 16 and flexible base material 18. In other words, in embodiments, a flexible base material may be bonded directly with a nano-particle material layer (e.g. third nano-particle material layer 26) or indirectly through a linking agent layer (e.g. first linking agent layer 18).

In embodiments, a flexible base material and linking agent material layer(s) may have the same, similar, and/or compatible elastic properties. In other words, when flexible base material is deformed through stress, straining, or shrinking, the elasticity of linking agent material layer(s) may not prevent a flexible base material from deforming since it is elastically compatible with the flexible base material. Since nano-particle material layer(s) include individual nano-particles that are independently bonded to an adjacent flexible base material and/or linking agent material layer(s), nano-particle material layer(s) may not prevent a flexible base material from deforming, in accordance with embodiments. Further, during deformation of a flexible base material, nano-particle material layers may not be subjected to significant mechanical strain, since there is substantially no bonding between adjacent nano-particles in the nano-particle material layer(s), in accordance with embodiments.

Nano-particles (e.g. nano-particles 20, nano-particles 22, and/or nano-particles 24) may be formed through a self-assembly, in accordance with embodiments. U.S. patent application Ser. No. 10/774,683 (filed Feb. 10, 2004 and titled “RAPIDLY SELF-ASSEMBLED THIN FILMS AND FUNCTIONAL DECALS”) is hereby incorporated by reference in its entirety. U.S. patent application Ser. No. 10/774,683 discloses self-assembly of nano-particles, in accordance with embodiments. In embodiments, the size (i.e. diameter or substantial diameter) of the nano-particles may be less than approximately 1000 nanometer. In embodiments, the size of the nano-particles may be less than approximately 50 nanometers. In embodiments, nano-particles may be gold and/or gold clusters. However, in other embodiments, nano-particles may be other metals (e.g. silver, palladium, copper, or other similar metal) and/or metal clusters. In embodiments, nano-particles may include metals, metal oxides, inorganic materials, organic materials, and/or mixtures of different types of materials. In embodiments, nano-particles may be semiconductor materials or non-conductive materials.

Through self assembly, nano-particles may be substantially uniformly and/or spatially dispersed during deposition to form a self assembled film, in accordance with embodiments. The self assembly of nano-particles may utilize electrostatic and/or covalent bonding of the individual nano-particles to a host layer (e.g. a linking agent material layer and/or a flexible base material). A host layer may be polarized in order to allow for the nano-particles to bond to the host layer, in accordance with embodiments. Since the deposition of the nano-particles may be dependent on individual bonding of the nano-particles to the host layer, a nano-particle material layer may have a thinkness that is approximately the diameter of the individual nano-particles. Through a self-assembly deposition method, nano-particles that do not bond to a host layer may be removed, so that a nano-particles material layer is formed that is relatively uniform in thinkness and material distribution.

Linking agent material layer(s) (e.g. first linking agent material layer 16 and/or second linking agent material layer 12) may be a material that is capable of covalently and/or electrostaticly bonding to nano-particles, in accordance with embodiments. U.S. patent application Ser. No. 10/774,683 (which is incorporated by reference above) discloses examples of materials which may be included in linking agent material layer(s). Linking agent material layer(s) may include polymer material. In embodiments, the polymer material may include poly(urethane), poly(etherurethane), poly(esterurethane), poly(urethane)-co-(siloxane), poly(dimethyl-co-methylhydrido-co-3-cyanopropyl, methyl) siloxane, and/or other similar materials. Linking agent material layer(s) may include materials that are polarized, in order for bonding with nano-particles, in accordance with embodiments.

In embodiments, linking agent material layer(s) may include a flexible material, an elastic material, and/or an elastomeric polymer. Accordingly, when nano-particles are bonded to sites of material in a linking agent material layer, then the nano-particle material layer may assume the same elastic, flexible, and/or elastomeric attributes of the host linking agent material layer, in accordance with embodiments. This physical attribute may be attributed by the individual bonding of substantially each nano-particle (of a nano-particle material layer) to a site of the linking agent material layer through either covalent and/or electrostatic bonding. Accordingly, when a linking agent material layer is shrunk, stretched, strained, and/or deformed, bonded nano-particles will move with sites of the linking agent material layer to which they are bonded, thus avoiding any disassociation of the nano-particles from their host during deformation.

In embodiments, flexible base material 18 may include a shrinkable material. For example, flexible base material 18 may include a shrinkable polymer. An example of a shrinkable polymer is polyvinyl chloride polyethylene terephthalate (e.g. PVC/PET or “shrink wrap”) or a material with similar properties. In embodiments, flexible conductive material 18 may first be formed on a shrinkable flexible base material 18 (e.g. FIGS. 1A and 2A) and then after formation of the flexible conductive material 18 be shrunk (e.g. FIGS. 1B and 2B). As shown in FIGS. 1B and 2B, nano-particles 20, 22, and/or 24 become closer together after shrinking (compared to the distances between adjacent nano-particles in FIGS. 1A and 2A). In embodiments, when the nano-particles become closer together due to shrinking, the electrical interaction between adjacent nanoparticles increases, thus increasing conductivity. Accordingly, shrinking of the flexible base material may be an effective and/or efficient means to increase the conductivity of the flexible conductive layer.

Note that the thicknesses in FIGS. 1A, 1B, 2A, 2B, 3A, 4B are shown for illustration and are not drawn to scale. In embodiments, the thickness of the flexible conductive layer is significantly less than the thickness of the flexible base material. Accordingly, since the material in the flexible base material and the flexible conductive material are elastically compatible, deformation, shrinking, and/or stretching of the flexible base material cause the flexible conductive material to comply with the flexible base material by deforming shrinking, and/or stretching.

In embodiments illustrated in FIGS. 3A, 3B, 4A, and 4B, flexible base material 36 may have stretchable properties. For example, the stretchable properties may allow flexible base material 36 to be stretched and/or strained by at least 1000% by mechanical, electrical, thermal, and/or light stimulus. In embodiments, a stretchable flexible base material (e.g. flexible base material 36) may include biaxially oriented polyethylene terephthalate material (e.g. Mylar) or a material with similar properties. In embodiments, flexible base material 36 may include a shape memory polymer.

FIG. 3A illustrates to first linking agent material layer 34 (of flexible material layer 31) bonded to flexible base material 36. First linking agent material layer 34 may be also bonded to first nano-particle material layer 32. First nano-particle material layer 32 may be also bonded to second linking agent material layer 30. Second linking agent material layer 30 may be also bonded to second nano-particle material layer 28. Although only two linking agent layers (i.e. first linking agent material layer 34 and second linking agent material layer 30) and two nano-particle material layers (i.e. first nano-particle material layer 32 and second nano-particle material layer 28) are illustrated, embodiments may include any number of linking agent material layers and nano-particle material layers (including just one nano-particle material layer and/or linking agent material layer).

First nano-particle material layer 32 includes nano-particles 40. In embodiments, nano-particles 40 may be conductive nano-particles (e.g. nano-size gold clusters). Nano-particles 40 may be individually bonded to first linking agent material layer 34. Bonding of nano-particles 40 to first linking agent material layer 34 may be either electrostatic bonding and/or covalent bonding. Nano-particles 40 may not be substantially bonded to each other. Accordingly, as first linking agent material layer 34 expands or contracts, the bond between the nano-particles 40 and first linking agent material layer 34 is not significantly compromised.

Although nano-particles 40 in first nano-particle material layer 32 are not bonded to each other, nano-particles 40 may be arranged close enough to each other, such that they may be electrically coupled to each other. In other words, in embodiments, electrical current may flow between adjacent nano-particles 40 in first nano-particle material layer 32. In fact, in embodiments, the rate of electrical conduction (i.e. electrical resistance) in first nano-particle material layer 32 (e.g. including gold nano-clusters) may be comparable and/or exceed that of solid gold (due to lattice inefficiencies in solid gold). Stretching of first linking material layer 34 with flexible base material 36 (shown in FIG. 3A) may decrease the conductivity of first nano-particle material layer 32 (due to an increase in distance between neighboring nano-particles 40). In embodiments, this decrease in conductivity may have unique applications, such as sensors (e.g. strain sensors, temperature sensors, pressure sensors, and other types of sensors).

Second linking agent material layer 30 may also be bonded to first nano-particle material layer 32, with the same or similar bonding mechanism as the bonding between first nano-particle material layer 32 and first linking agent material layer 34, in accordance with embodiments. In embodiments, first linking agent material layer 34 and second linking agent material layer 30 may include the same material and/or configuration. In embodiments, first linking agent material layer 34 and second linking agent material layer 30 may include different materials and/or configurations.

Second nano-particle material layer 28 may be bonded to second linking agent material layer 30 with the same or similar bonding mechanism as the bonding between first nano-particle material layer 32 and first linking agent layer 34. Additional linking agent material layer(s) and/or nano-particle material layer(s) may be formed over second nano-particle material layer 28, in accordance with embodiments. In embodiments, first nano-particle material layer 32 and second nano-particle material layer 28 may include the same material (i.e. nano-particles 38 and nano-particles 40 may be the same type of nano-particles) and/or configuration. In embodiments, first nano-particle material layer 32 and second nano-particle material layer 28 may include different materials (i.e. nano-particles 38 and nano-particles 40 may be different types of nano-particles) and/or configurations.

As illustrated in example FIGS. 4A and 4B, a nano-particle material layer (e.g. third nano-particle material layer 42 with nano-particles 44) may be formed between first linking agent layer 34 and flexible base material 36. In other words, in embodiments, a flexible base material may be bonded directly with a nano-particle material layer (e.g. third nano-particle material layer 42) or indirectly through a linking agent layer (e.g. first linking agent layer 36).

Strain Sensor

Embodiments relate to low-modulus strain sensors which may allow the measurement of integrated strain along their gage length. In embodiments, a self-assembled free-standing sensor material may be formed using conductive nano-particles in accordance with the structure described with respect to FIGS. 1A, 1B, 2A, 2B, 3A, 4A and 4B. The sensor material may be constructed in a sheet or strip form to have a nominal resistance in its natural (unstrained) condition (e.g., 30 ohms, 100 ohms, etc.). When a sheet of the sensor material is deformed, the strain in the sheet varies over its area and the resistance similarly varies over its area. By measuring the change in resistance as function of position over the area of the sheet, the distribution of strain over the area may be determined.

Multiple measurements of resistance from point to point across the surface of the flexible, conductive sensor material allow a determination of a two-dimensional strain and shape of the sensor material and any substrate to which it is attached.

The volume percentage of conductive nano-particles or nano-clusters in the flexible material layer may be tailored to allow for an optimal conductivity percolation. Accordingly, when the volume percentage of conductive nano-particles is near the percolation threshold, the change in conductivity for relatively small changes of the material may be relatively large, in accordance with embodiments.

Example FIG. 5 illustrates a strain sensor arrangement 500 in accordance with embodiments. The strain sensor 510 includes a flexible sensor material that exhibits changes in conductivity as the material shrinks, stretches, and otherwise deforms. Electrodes 520 are electrically coupled with the sensor 510 so that conductivity between the two electrodes 520 may be measured. Although only two electrodes are depicted, more electrodes may be present or the location of the electrodes may vary. FIG. 5 does not explicitly depict the control electronics and other analysis equipment that couples with the electrodes 520 when actual analysis of a material is being performed.

Structural Health

In the strain sensor described above, the flexible sensor material maintains substantially the same conductivity parameters over its useful lifetime. However, if the flexible sensor material is relatively stiffer, then its conductivity parameters may change over time as the material is repeatedly deformed.

A self-assembled free-standing sensor material may be formed that can be embedded or attached to a substrate such as an airplane wing or other structural member. Conductive leads are attached to the sensor material so that conductivity may be measured even if the sensor material is embedded within another structure. The sensor material may be tailored so that resistance/conductivity changes as a function of the number of times the material is strained, thus serving as a fatigue sensor to indicate material degradation.

Temperature Sensor

In embodiments, flexible sensor material may be annealed by passing an electrical current through it. The electrical current may modify the electrical pathways between adjacent electrically conducting nano-particles and nano-clusters. Such modification may also be accomplished using thermal annealing as well. The annealing may cause coalescence of conductive nano-clusters, which may lead to higher conductivity. Thus, an annealing temperature may be tailored according different desired size nano-clusters. Once formed and annealed, the flexible sensor material will have the characteristic that its conductivity will vary according to its temperature.

Pressure Sensor

Embodiments relate to pressure sensors that include flexible sensor material. Such material may be used in the shape of a diaphragm that is supported over a chamber, in accordance with an embodiment. When the pressure outside the chamber changes with respect to the pressure inside the chamber, the diaphragm may be strained. The resulting resistance change of the strained material may be measured and used to determine the corresponding change in pressure.

Volume Sensor

Volume sensors may include the flexible sensor material which can be bonded to the outside or inside of a container or a portion thereof. A change in resistance of the flexible sensor material corresponds to a change in shape (and thus volume) of the container.

Chemical Sensor

Different flexible sensor materials may be made with nano-particles or nano-clusters that corrode differently when exposed to corrosion atmospheres. Corrosion may modify the nano-particles and may affect electron transfer, thus increasing resistivity. Alternatively, nano-particles may be used that are susceptible to bonding with known chemicals such that once bonding occurs, electron transfer is affected. Thus, in embodiments, a change in resistivity of the flexible sensor material may indicate the absence or presence of a chemical.

Skin Friction Sensor

In embodiments similar to the strain sensor described earlier, the flexible sensor material may be located on the surface of a substrate or between two substrates. The change in conductivity of the sensor material can be detected which is caused by shear forces or normal forces which deform the sensor material.

Magnetic Sensor

In embodiments, the flexible sensor material may include nano-particles that exhibit giant magnetoresistance (GMR) properties, whereby their electrical resistance varies with an applied magnetic field. Embodiments relate to GMR sensor devices using mechanically flexible materials.

In embodiments, the flexible sensor material may have hysteretic B/H behavior, which may be used as part of an acoustic detection system. Pulsed magnetic fields may induce local thermal heating of the flexible sensor material, which may lead to the generation of acoustic waves. The acoustic waves may be detected as part of a measurement or imaging system.

In addition to the flexible sensor material which includes conductive nano-particles that exhibit a variation in conductivity in response to some stimulus, other flexible sensor materials are contemplated as well. For example, the nano-particles may be tailored to construct thermal conducting materials or optical conducting materials such that thermal or optical properties of the material vary in response to a stimulus and such variance is detected.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An sensor comprising:
a flexible base material having at least one of shrinkable and stretchable properties; and
a flexible material layer formed on the flexible base material, wherein the flexible material layer comprises at least one nano-particle layer and at least one linking agent layer,
said at least one nano-particle layer is bonded to said at least one linking agent layer, and
the flexible nano-particle layer having a physical attribute changeable in response to a stimulus.

2. The sensor of claim 1, wherein the flexible material layer having at least one of shrinkable and stretchable properties

3. The sensor of claim 1, wherein the at least one nano-particle layer comprises conductive nano-particles.

4. The sensor of claim 1, wherein said physical attribute comprises a physical spacing between nano-particles of the at least one nano-particle layer.

5. The sensor of claim 1, wherein said physical attribute comprises conductivity of the nano-particle layer.

6. The sensor of claim 1, wherein said physical attribute comprises electromagnetic resonance.

7. The sensor of claim 1, wherein said physical attribute comprises optical transmissivity.

8. The sensor of claim 1, wherein said physical attribute comprises thermal conductivity.

9. The sensor of claim 1, wherein the flexible base material comprises a shrinkable polymer.

10. The sensor of claim 1, wherein the stretchable properties allow the flexible base material to be strained by at least 1000% by at least one of mechanical, electrical, thermal, and light stimulus.

11. The sensor of claim 1, wherein the flexible base material comprises a shape memory polymer.

12. The sensor of claim 3, wherein said conductive nano-size particles comprises gold nano-size particles.

13. The sensor of claim 9, wherein said gold nano-size particles comprises gold clusters each having a diameter less than approximately 1000 nanometers.

14. The sensor of claim 10, wherein said gold nano-size particles comprises gold clusters having a diameter less than approximately 50 nanometers.

15. The sensor of claim 1, wherein:
said at least one nano-particle layer is bonded to said at least one linking agent layer by at least one of electrostatic bonding and covalent bonding; and
at least one of said at least one nano-particle layer and said at least one linking agent layer are bonded to the flexible base material by at least one of electrostatic bonding and covalent bonding.

16. The sensor of claim 1, wherein:
said at least one linking agent layer is an elastomeric polymer;
individual particles of said at least one nano-particle layer are bonded to sites of the elastomeric polymer; and
at least one of individual particles of said at least one nano-particle layer and sites of the elastomeric polymer are bonded to sites of the flexible base material.

17. The sensor of claim 18, wherein the flexible base material comprises at least one of:
PET;
PVC/PET;
polyurethane;
polysiloxane;
a poly(urethane-soloxane) copolymer;
poly(vinyl chloride);
polyisoprene-cis;
polyisobutylene;
polybutadiene;
styrene butadiene copolymers (SBR);
nitrile rubber;
an acrylonitrile-butadiene random copolymer;
butyl rubber;
an isoprene-isobutylene copolymer;
an acrylonitrile-butadiene-styrene copolymer;
polychloroprene; and
poly(ethylene-stat-propylene).

18. The sensor of claim 1, wherein the stimulus is at least one of mechanical strain, deformation, optical energy, heating, cooling, acoustic energy, and electromagnetic energy.

19. A method for constructing a sensor comprising:
forming a flexible base material having at least one of shrinkable and stretchable properties; and
forming a flexible material layer formed on the flexible base material, wherein the flexible material layer comprises at least one nano-particle layer and at least one linking agent layer,
said at least one nano-particle layer is bonded to said at least one linking agent layer, and
the flexible nano-particle layer having a physical attribute changeable in response to a stimulus.

20. The method of claim 19, wherein the at least one nano-particle layer comprises conductive nano-particles.
